(19) United States
(12) Patent Application Publication
(10) Pub. No.: US 2012/0018024 A1
(43) Pub. Date: Jan. 26, 2012

(54) Corrugated Pipe of a Fuel Line

(75) Inventors: Dieter HAGIST, Lahnstein (DE); Helmut Nather, Bad Camberg (DE)

(73) Assignee: Continental Automotive GmbH, Hannover (DE)

(21) Appl. No.: 13/190,348

(22) Filed: Jul. 25, 2011

(30) Foreign Application Priority Data
Jul. 26, 2010 (DE) 10 2010 032 220.2

(51) Int. Cl. F16L 11/00

(52) U.S. Cl. 138/121

(57) ABSTRACT

A corrugated pipe of a fuel line of a fuel supply system of a motor vehicle, with at least one flexible wavy portion having waves. The waves are a wave crest and of a wave trough. The at least one wavy portion has a region, the cross section of which has a form deviating from the circular form.

### BACKGROUND OF THE INVENTION

1. Field of the Invention

The invention relates to a corrugated pipe of a fuel line of a fuel supply system of a motor vehicle, with at least one flexible wavy portion having waves, each of the waves having a wave crest and of a wave trough.

2. Description of the Related Art

Corrugated pipes are often used in present-day fuel supply systems of present-day motor vehicles to connect a fuel pump to a filter or to a flange of a fuel feed unit and are known from practice. In the known fuel supply system, the corrugated pipe is pushed with an end portion onto a connection piece of the fuel pump, said connection piece mostly having a pinetree profile. For this purpose, the end piece is configured cylindrically. The wavy portion enables the corrugated pipe, which serves for the compensation of tolerances of the fuel supply system, to have flexibility. Furthermore, depending on the filling level in the fuel tank, relative movements arise between the fuel pump and the flange that are compensated by the corrugated pipe.

A disadvantage of the known corrugated pipe is that undesirable pressure pulsations in the forward flow line leading from the fuel pump to the internal combustion engine of the motor vehicle are conducted through the corrugated pipe and cause noises there. Noises in the fuel tank are fundamentally disturbing because of its position in the motor vehicle. Moreover, pressure pulsations are basically disadvantageous, since, depending on magnitude and duration, they may lead to damage to components arranged downstream.

### SUMMARY OF THE INVENTION

One embodiment of the invention is a corrugated pipe of the type initially mentioned that counteracts pressure pulsations and noises generated thereby.

According to one embodiment of the invention, at least one wavy portion possesses at least one region, the cross section of which has a form deviating from circular form.

On account of their cross-sectional geometry, these regions can vary their cross section in the event of pressure pulsations. This change contributes to the damping of pressure pulsations and of noises thereby occurring.

A single region is arranged in a wavy portion or a plurality of regions may also be arranged in the wavy portion. The damping of pressure pulsations can be further reinforced as a result. Insofar as the corrugated pipe has a plurality of wavy portions, one or more regions may be arranged in one, a plurality of or all wavy portions.

In one embodiment, the region has an oval cross section. Depending on the design of the oval cross section, a greater or lesser deviation from the circular form can be achieved. The degree of deviation is a measure of the deformability of the respective region and consequently of the damping of pressure pulsations. Corrugated pipes can thus be adapted deliberately to the pressure pulsations that arise.

A refinement of the corrugated pipe which is especially beneficial in manufacturing terms is afforded when the cross section of the region is formed by two segments of an arc of a circle which lie opposite one another, and the two segments of an arc of a circle are connected to one another by rectilinear segments. In particular, the rectilinear segments can be generated cost-effectively. Furthermore, it is precisely these segments that offer a high deformation potential having a positive effect upon damping.

Damping of the pressure pulsations, along with a sufficient stability of the regions, is achieved by a cross section in which the regions formed by at least three segments of an arc of a circle, adjacent segments of an arc of a circle being connected to one another by rectilinear segments.

Especially simple production of the corrugated pipe according to one embodiment of the invention is achieved when the cross sections of all the regions possess the same orientation in one, a plurality of, or all the wavy portions.

The cross section deviating from the circular form causes the corrugated pipe to occupy a varied construction space along its installation path, as compared with conventional corrugated pipes. In cases where the construction space is limited in one direction in this way, the corrugated pipe according to one embodiment of the invention can nevertheless be used if the cross sections of the regions possess a different orientation. This refinement makes it possible to adapt the orientation of the cross sections to the available construction space. If a corrugated pipe were installed in a horizontal plane and were deflected through 180° within this plane, a region with an orientation of its cross section in which the greatest extent is arranged perpendicularly to the plane would scarcely contribute to damping on account of the bending radius. This is because the deformable portions are already deformed as a result of the deflection of the corrugated pipe and can therefore undergo only insignificant deformation in the event of pressure pulsations. The damping then achieved is correspondingly low. If the regions are oriented so as to be offset at 90°, the deformable regions are arranged parallel to the horizontal plane. The deformation caused by deflection is then absorbed by the change in length of the corrugated pipe, and the deformable regions continue to be available for damping pressure pulsations. Moreover, the deformable regions may be arranged even in such portions. Since the installation path of the corrugated pipe can thus be utilized more effectively, the corrugated pipe according to one embodiment of the invention can have a shorter configuration.

The transitions between circular cross sections and cross sections with cross sections deviating from the circular form can be configured especially simply in manufacturing terms if each region has a plain pipe portion at each of its two ends, the plain pipe portions in each case connecting one end of the region to the wavy portion or to an adjacent region. Moreover, the propagation of pressure pulsations is disturbed at these transitions, thus contributing to further damping of the pressure pulsations and of the noises associated with these.

Minor disturbance of the flow through the transitions is achieved if the plain pipe portions are configured such that continuous transition between the two cross sections takes place.

In a simple refinement, the at least one region is arranged symmetrically in the wavy portion with respect to the length of the corrugated pipe. As a result of the symmetrical arrangement of the region, calming of the flow is achieved after each change in cross section. In adaptation to the available construction space, it may be advantageous if at least one region is arranged asymmetrically to the respective wavy portion with respect to the length of the latter.

The flow is led relatively uniformly through the corrugated pipe when the cross-sectional area of the regions is equal to the cross-sectional area of the wavy portion, the different cross sections of a wave trough and of a wave crest in this case being ignored.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention permits numerous embodiments. To make its basic principle even clearer, some of these are illustrated in the drawing and are described below. In the drawing:

FIG. 1 is a perspective illustration of a corrugated pipe according to one embodiment of the invention;

FIG. 2 is a sectional illustration of the corrugated pipe from FIG. 1;

FIG. 3 is a cross section of the corrugated pipe from FIG. 2;

FIGS. 3a-3c are various cross sections of the corrugated pipe in a diagrammatic illustration;

FIGS. 4a, b are the corrugated pipe from FIG. 1 in different orientations; and

FIGS. 5-7 are further versions of the corrugated pipe according to the invention in a diagrammatic illustration.

### DETAILED DESCRIPTION OF THE PRESENTLY PREFERRED EMBODIMENTS

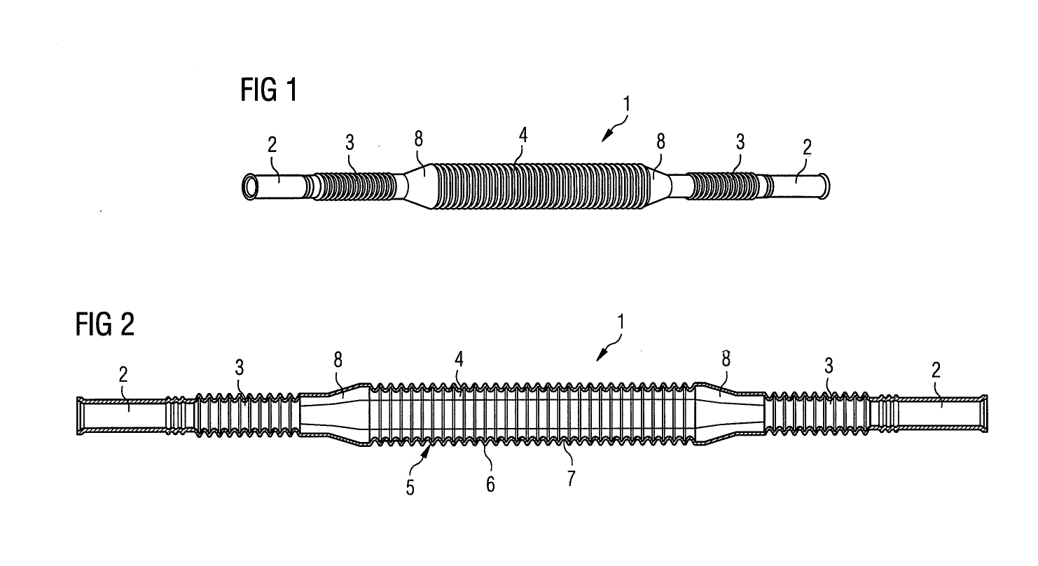

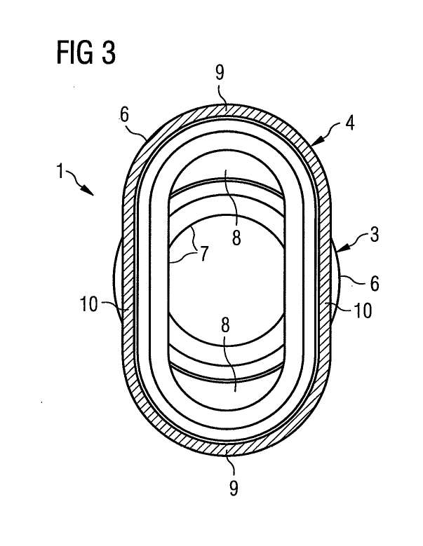

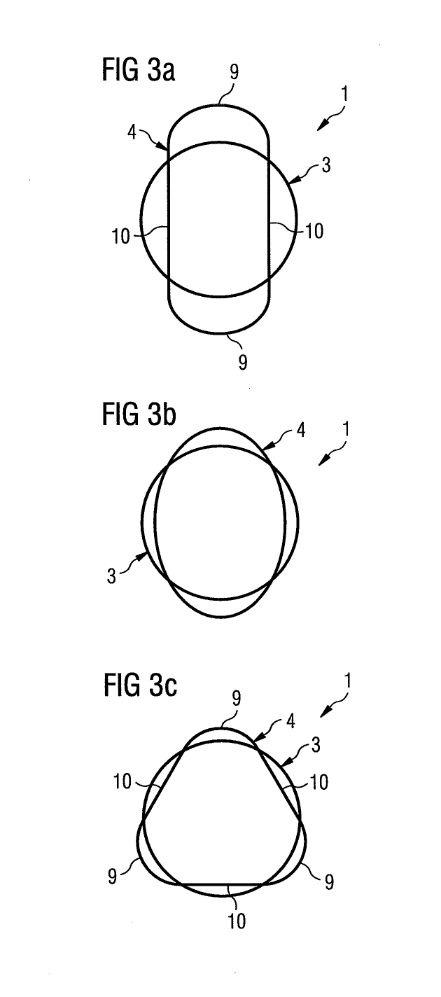

FIG. 1 shows a corrugated pipe 1, such as is used in a fuel feed unit of a fuel tank for a motor vehicle. The corrugated pipe 1 is in this case part of the forward flow line that connects the outlet of a fuel pump to the end of the motor vehicle. The corrugated pipe 1 possesses end pieces 2 designed as plain pipe and are used for mounting. The corrugated pipe 1 has at least one wavy portion 3 that extends between the end pieces 2 over the remaining run of the corrugated pipe 1. The wavy portion 3 has a circular cross section. Arranged symmetrically in the wavy portions 3 is a region 4, the cross section of which is illustrated in FIG. 3.

As shown in FIG. 2, the wavy portion 3 and the region 4 possess waves 5 which are formed in each case by a wave crest 6 and a wave trough 7. The transitions from the wavy portion 3 to the region 4 are formed by plain pipe portions 8. The plain pipe portions 8 in FIG. 2 have a conical form on account of the different cross sections of the wavy portion 3 and of the region 4, the wall thickness of corrugated pipe 1 being constant.

The region 4 has a cross section that deviates from the circular form and that is illustrated in FIG. 3. This cross section is composed of two segments 9 of an arc of a circle which lie opposite one another. The two segments 9 of an arc of a circle are connected to one another by rectilinear segments 10. When pressure pulsations arise, the cross section of the region 4 is deformed in that it approaches a circular form. This deformation takes place primarily in the rectilinear segments 10. This deformation of the region 4 leads to damping of the pressure pulsations.

FIG. 3a shows a corrugated pipe 1 according to FIG. 3 in a diagrammatic illustration. The corrugated pipe 1 in FIG. 3b possesses an oval cross section in the region 4, here too the vertical portions of the oval cross section assuming the largest share of the deformation. In FIG. 3b, the region 4 has a substantially oval cross section. In FIG. 3c, the region 4 possesses a polygonal cross section in the form of a triangle. This cross section possesses three segments 9 of an arc of a circle, adjacent segments 9 of an arc of a circle being connected to one another via rectilinear segments 10. The circular cross section of the wavy portion 3 can be seen in all the FIGS. 3a-c. Particularly in FIGS. 3a and 3b, the circular cross section possesses a greater horizontal extent than the cross section of the region 4. By contrast, the cross section of the region 4 possesses the greater extent in the vertical direction. What is achieved by these configurations is that the cross-sectional area remains approximately the same in the overall corrugated pipe 1, this having a positive effect upon the flow.

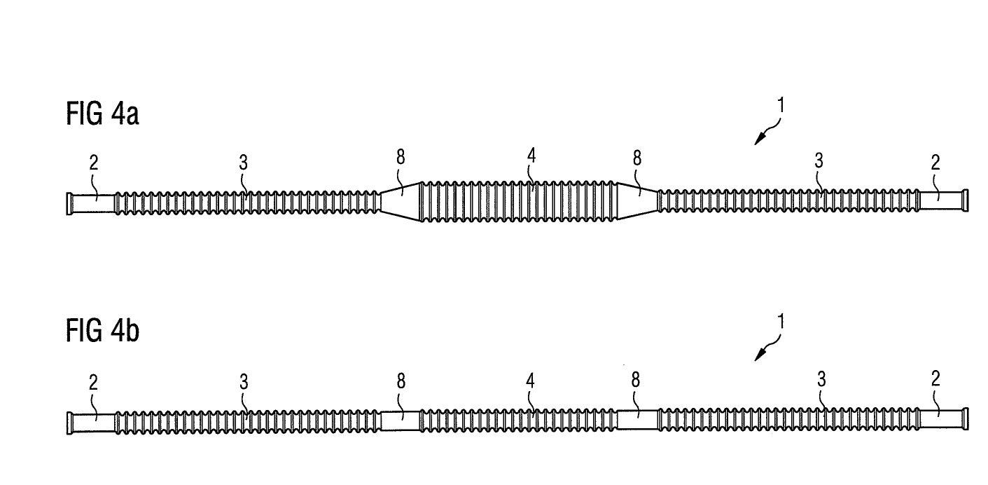

FIGS. 4a, b show the corrugated pipe 1 from FIG. 1, the orientation of the region 4 in FIG. 4b being arranged so as to be offset at 90° with respect to FIG. 4a.

FIG. 5 shows a corrugated pipe 1 with two wavy portions 3, 3″ a region 4 in each case being arranged in each wavy portion 3, 3″.

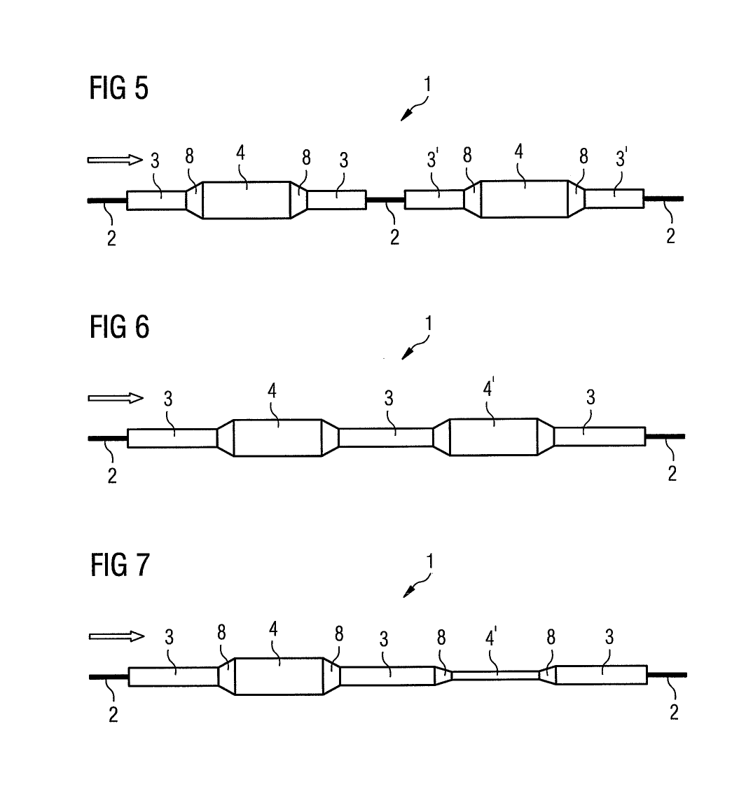

In FIG. 6, the corrugated pipe 1 has a wavy portion 3, along the run of which are arranged two regions 4, the regions 4 having the same orientation.

In contrast to this, FIG. 7 shows a corrugated pipe 1 with two regions 4, 4′, the orientations of which are rotated at 90° with respect to one another. For clearer illustration, it was thought unnecessary to reproduce the waves 5 in FIGS. 5-7.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A corrugated pipe of a fuel line of a fuel supply system of a motor vehicle, comprising:
at least one flexible wavy portion having a plurality of waves, each of the plural waves comprising a wave crest and a wave trough; and
at least one region of the at least one flexible wavy portion has a cross section having a form that deviates from a circular form.

2. The corrugated pipe as claimed in claim 1, wherein the at least one region has an oval cross section.

3. The corrugated pipe as claimed in claim 1, wherein the cross section of the at least one region is formed by two segments of an arc of a circle that lie opposite one another, the two segments of the arc of the circle are connected to one another by rectilinear segments (10).

4. The corrugated pipe as claimed in claim 1, wherein the cross section of the at least one region is formed by at least three segments of an arc of a circle, adjacent segments being connected to one another by rectilinear segments (10).

5. The corrugated pipe as claimed in claim 1, wherein cross sections of the at least one region in one or more of the flexible wavy portions have a same orientation.

6. The corrugated pipe as claimed in claim 1, wherein cross sections of the at least one region has a different orientation.

7. The corrugated pipe as claimed in claim 1, wherein each of the at least one region has a plain pipe portion at each of its two ends, plain pipe portions in each case connecting one end of the at least one region to one of the wavy portion and to an adjacent region.

8. The corrugated pipe as claimed in claim 7, wherein the plain pipe portions are configured for continuous transition between the adjacent regions.

9. The corrugated pipe as claimed in claim 1, wherein the at least one region is arranged asymmetrically with respect to a length of the wavy portion.

10. The corrugated pipe as claimed in claim 1, wherein a cross-sectional area of the at least one region is equal to a cross-sectional area of the wavy portion.
